(19) United States
(12) Patent Application Publication
(10) Pub. No.: US 2020/0031712 A1
(43) Pub. Date: Jan. 30, 2020

(54) METHOD FOR MANUFACTURING LIGHT CONTROL PANEL, LIGHT CONTROL PANEL, OPTICAL IMAGING DEVICE, AND AERIAL IMAGE FORMING SYSTEM

(71) Applicant: MATSUNAMI GLASS IND., LTD., Osaka (JP)

(72) Inventors: Atsushi NAKANO, Osaka (JP); Kazuhisa ISHII, Osaka (JP); Kenjiro NAKAMOTO, Osaka (JP); Ko SAWACHIKA, Osaka (JP)

(21) Appl. No.: 15/580,413

(22) PCT Filed: Sep. 5, 2016
(86) PCT No.: PCT/JP2016/076061

§ 371 Date: Dec. 7, 2017

(30) Foreign Application Priority Data
Sep. 8, 2015 (JP) 2015-176322

(51) Int. Cl. C03C 27/10; G02B 27/22; G02B 5/08; G02B 17/00; G02B 27/01

(52) U.S. Cl. CPC C03C 27/10; G02B 27/2292; G02B 27/0101; G02B 17/002; G02B 27/2278; G02B 5/085

(57) ABSTRACT

In a method for manufacturing a light control panel, a large number of strip-shaped reflective surfaces are formed with a constant pitch in a direction that is perpendicular to a thickness direction of the light control panel. The method includes a stacking step of directly stacking a large number of elongated flat plate-shaped glass pieces one on top of another without interposing an adhesive between the glass pieces, thereby producing a glass stack, which has a flat plate-like shape and in which the large number of glass pieces are lined up in a direction that is perpendicular to a thickness direction of the glass stack; and an integrating step of integrating the large number of Mass pieces of the glass stack. Pieces of transparent glass with no reflective films for forming the strip-shaped reflective surfaces being stacked thereon are used as the glass pieces.

### TECHNICAL FIELD

The present invention relates to a method for manufacturing a light control panel for use in an optical imaging device that forms an image in the air, and the like.

### BACKGROUND ART

Conventionally, a light control panel in which a large number of strip-shaped reflective surfaces are formed with a constant pitch in a direction that is perpendicular to a thickness direction of the light control panel is known as an optical element for forming an image in the air. An optical imaging device that forms an image in the air can be configured by using two such light control panels, and stacking the two light control panels one on top of the other such that their strip-shaped reflective surfaces are substantially orthogonal to each other.

Patent Document 1, for example, discloses a method for manufacturing a light control panel. In this manufacturing method, a light control panel is formed by forming a block in which transparent sheets (glass, transparent plastic, etc.) and mirror sheets (mirror sheets to which a UV-curable adhesive is applied) are alternatingly stacked and then cutting the block into a constant thickness along a plane that intersects the transparent sheets. The transparent sheets and the mirror sheets are joined together with the UV-curable adhesive.

### CITATION LIST

### Patent Documents

Patent Document 1: WO 2014/073650

### SUMMARY OF INVENTION

### Technical Problem

Incidentally, in the conventional light control panel, adhesive layers (adhesive layers formed of the UV-curable adhesive) are provided between adjacent ones of a large number of glass pieces that are stacked one on top of another. In the light control panel, a large number of adhesive layers are provided. Therefore, a large amount of adhesive is required in order to manufacture a light control panel, and it is difficult to manufacture a light control panel at low cost.

The present invention was made in view of the foregoing circumstances, and it is an object thereof to reduce the manufacturing cost of a light control panel by reducing an adhesive that is used to manufacture the light control panel.

### Solution to Problem

In order to address the above-described problems, a method for manufacturing a light control panel according to the present invention is a method for manufacturing a light control panel in which a large number of strip-shaped reflective surfaces are formed with a constant pitch in a direction that is perpendicular to a thickness direction of the light control panel, the method including a stacking step of directly stacking a large number of elongated flat plate-shaped glass pieces one on top of another, thereby producing a glass stack, which has a flat plate-like shape and in which the large number of glass pieces are lined up in a direction that is perpendicular to a thickness direction of the glass stack, and an integrating step of integrating the large number of glass pieces of the glass stack.

The integrating step of this manufacturing method may include a step of applying a transparent adhesive to at least one of one side of the glass stack and one side of a transparent cover plate, a step of stacking the cover plate on one side of the glass stack such that the adhesive is sandwiched between the glass stack and the cover plate, and a step of forming an adhesive layer by curing the adhesive between the glass stack and the cover plate.

Moreover, this manufacturing method may further include a cutting step of cutting a transparent glass sheet, thereby dividing the transparent glass sheet into a plurality of glass pieces for use in the stacking step, wherein polishing of side surfaces on the long sides of each glass piece may be not performed. In this case, protrusions and depressions remain on the side surfaces of each glass piece of the glass stack as marks that are formed during cutting.

Moreover, a light control panel according to the present invention is a light control panel in which a large number of strip-shaped reflective surfaces are formed with a constant pitch in a direction that is perpendicular to a thickness direction of the light control panel, the light control panel including a glass stack that has a flat plate-like shape and that is constituted by a large number of glass pieces that are directly stacked one on top of another in a direction that is perpendicular to a thickness direction of the glass stack and a fixation portion that integrates the large number of glass pieces of the glass stack, wherein, in each of the glass pieces, one of the principal surfaces of the glass piece that oppose each other in a thickness direction of the glass piece functions as the strip-shaped reflective surface.

Moreover, the fixation portion of this light control panel may have an adhesive layer that is in contact with one side of the glass stack and that is composed of a cured transparent adhesive, and a transparent cover plate that is adhesively bonded to a side of the adhesive layer, the side being opposite to the glass stack, in such a manner as to cover the one side of the glass stack.

Moreover, an optical imaging device according to the present invention includes two of the above-described light control panels, wherein the two light control panels are bonded to each other via a second adhesive layer such that their strip-shaped reflective surfaces are substantially orthogonal to each other, and the glass stacks of the light control panels face each other.

Moreover, an aerial image forming system according to the present invention includes the above-described optical imaging device and a reproducing device that is disposed behind the optical imaging device and that displays an image in a display based on electronic data, wherein an aerial image is formed by forming the image in the display in free space (in the air) in front of the optical imaging device.

### Advantageous Effects of Invention

According to the present invention, a flat plate-shaped glass stack is produced by directly stacking a large number of elongated flat plate-shaped glass pieces one on top of another. Unlike the conventional method, cutting out light control panels having a constant thickness from a stack of a large number of transparent sheets (a block in which mirror sheets are interposed between the transparent sheets) is not performed, but instead, the large number of glass pieces that are stacked one on top of another constitute a glass stack, which is one element of a light control panel. Moreover, unlike the conventional method, the large number of glass pieces are directly stacked one on top of another in the stacking step. No adhesive is provided between adjacent glass pieces in the stacking step. Accordingly, an adhesive in gaps between adjacent glass pieces 15, where a large amount of adhesive has conventionally been used, can be reduced, so that the manufacturing cost of the light control panel can be reduced.

It should be noted that a transparent glass piece with no metal reflective film (mirror) on either side can be used as each glass piece. Here, when the large number of glass pieces are directly stacked one on top of another, minute gaps are formed between adjacent glass pieces. For this reason, in the glass stack, light that is obliquely incident from side surfaces of the glass pieces is totally reflected by principal surfaces (surfaces opposing each other in the thickness direction of the glass pieces) of the glass pieces due to the difference between the refractive index of the glass pieces and the refractive index of air in the minute gaps. Even though no metal reflective film is provided on either side of each glass piece, light for forming an aerial image is properly reflected, and the light control panel functions properly. In this case, a large number of metal reflective layers (mirror sheets), which have conventionally been used, are no longer necessary, so that the manufacturing cost of the light control panel can be reduced even more.

Moreover, according to the present invention, unlike the conventional method, a block from which a plurality of light control panels are cut out is not produced, but instead, a glass stack used for a single light control panel is produced from a large number of glass pieces. Compared with the block, the glass stack is lightweight. Therefore, although it has conventionally been difficult to increase the size of a light control panel under constraints of the weight of the block, the constraints of the weight are alleviated according to the present invention, so that the size of a light control panel can be increased.

Moreover, the large number of glass pieces of the glass stack can be integrated by fixing the glass pieces to a single cover plate with an adhesive layer. In this case, the adhesive layer comes into intimate contact with a side surface of each glass piece and the cover plate. Therefore, even though polishing of the side surface (cut surface) of each glass piece is not performed, a side surface portion of each glass piece of the glass stack can be made transparent. Accordingly, polishing of the side surface of each glass piece can be omitted, so that the manufacturing cost of the light control panel can be reduced even more.

### BRIEF DESCRIPTION OF DRAWINGS

FIG. 1 is a side view of an optical imaging device according to an embodiment.

FIG. 2 is a diagram for illustrating formation of an aerial image using the optical imaging device according to the embodiment.

FIG. 3 shows diagrams for illustrating a method for manufacturing a light control panel.

FIG. 4 shows diagrams for illustrating methods for manufacturing a light control panel and an optical imaging device.

FIG. 5 is a diagram for illustrating a method for manufacturing a light control panel according to a modification.

### DESCRIPTION OF EMBODIMENTS

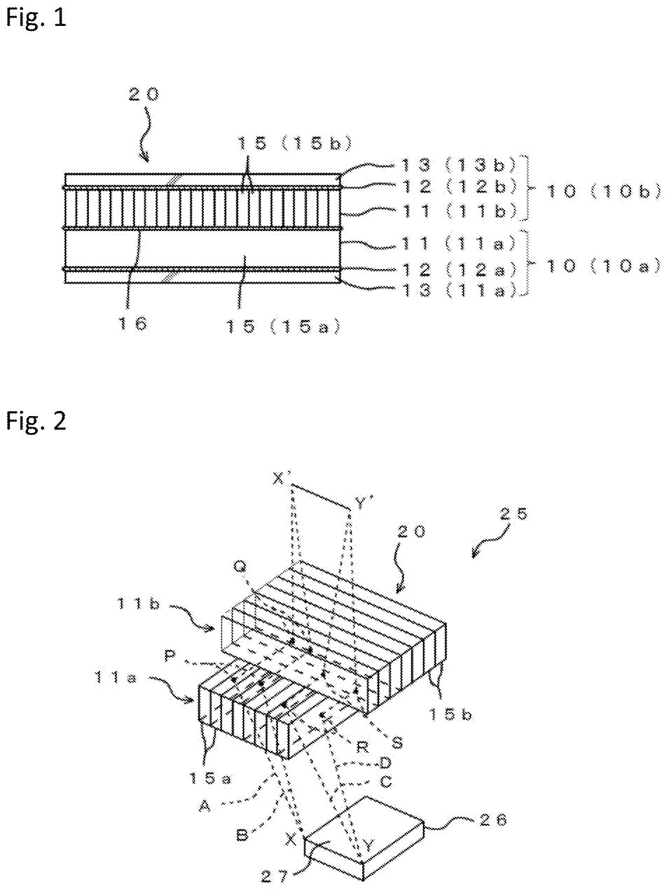

Hereinafter, an embodiment of the present invention will be described in detail with reference to FIGS. 1 to 4.

### 1. Light Control Panel

A light control panel 10 is an optical element in which a large number of strip-shaped reflective surfaces are formed with a constant pitch in a direction that is perpendicular to a thickness direction of the light control panel 10. As shown in FIG. 1, the light control panel 10 includes a glass stack 11, an adhesive layer 12 (first adhesive layer), and a cover plate 13. The glass stack 11 is obtained by stacking a large number of glass pieces 15 in a lateral direction. The adhesive layer 12 and the cover plate 13 are stacked on the glass stack 11 in that order. The adhesive layer 12 and the cover plate 13 correspond to a fixation portion that integrates the large number of glass pieces 15 of the glass stack 11. The large number of glass pieces 15 are fixed to each other and thus integrated.

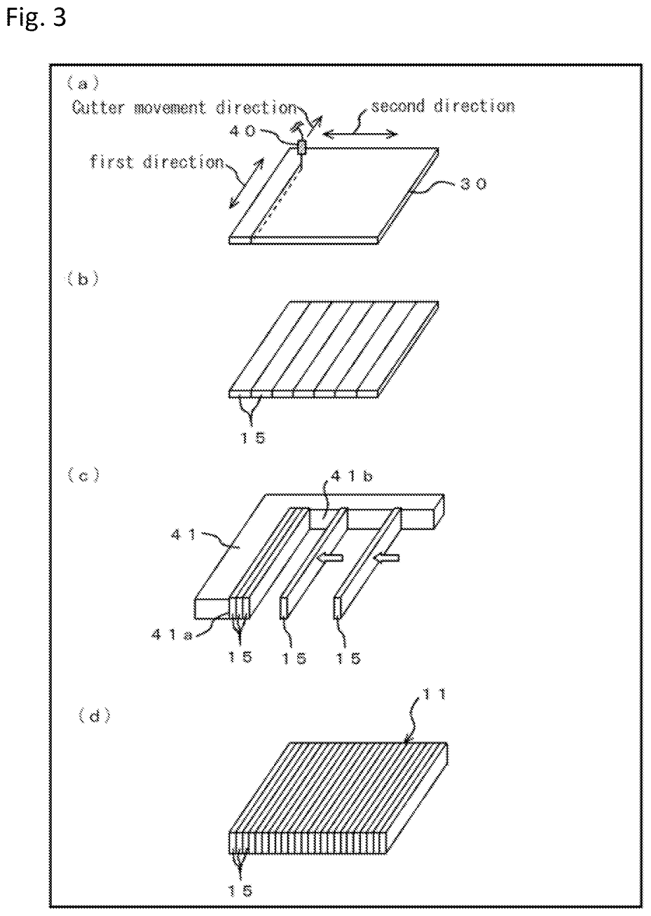

The glass stack 11 is obtained by stacking the large number of (e.g., 100 or more) elongated rectangular flat plate-shaped glass pieces 15 (glass bars) one on top of another. The large number of glass pieces 15 have the same dimensions (the same shape and the same size) and are stacked one on top of another without displacement. The glass stack 11 has a rectangular flat plate-like shape (is flat rectangular parallelepiped-shaped) (see FIG. 3(d)). In the glass stack 11, the large number of glass pieces 15 are directly stacked one on top of another in a direction that is perpendicular to a thickness direction of the glass stack 11. The glass pieces 15 that are adjacent to each other directly face each other without any other member, such as an adhesive, being interposed therebetween. A pair of principal surfaces (front and rear surfaces opposing each other in the thickness direction) of the glass stack 11 are formed to be substantially flat surfaces by side surfaces (side surfaces on the long side) of the large number of glass pieces 15 being lined up flush with one another.

For example, the glass pieces 15 each have dimensions of 1.5 mm wide on the short side (width), 300 mm long on the long side (length), and 0.5 mm thick. In the glass stack 11, 600 glass pieces 15, for example, are stacked one on top of another. The glass stack 11 has a rectangular parallelepiped shape having an about 300 mm×about 300 mm square shape in plan view and a thickness of 1.5 mm. It should be noted that the dimensions of the glass pieces 15 and the glass stack 11 are not limited to the dimensions described in this paragraph.

The adhesive layer 12 is a thin transparent layer that is in contact with one of the principal surfaces of the glass stack 11. The adhesive layer 12 is composed of an adhesive that has been applied to that principal surface of the glass stack 11 and cured. The adhesive layer 12 fixes the glass pieces 15 of the glass stack 11 to the cover plate 13. The adhesive layer 12 substantially entirely covers that principal surface of the glass stack 11.

The cover plate 13 is a thin sheet of transparent glass having a rectangular flat plate-like shape. For example, the cover plate 13 has a thickness that is approximately equal to the thickness of the glass pieces 15 and that is smaller than that of the glass stack 11. In plan view, the cover plate 13 has, for example, substantially the same size as the principal surface of the glass stack 11, and is adhesively bonded to a side of the adhesive layer 12 that is opposite to the glass stack 11 in such a manner as to entirely cover the principal surface. The sides of the cover plate 13 are substantially parallel to the respectively corresponding neighboring sides of the principal surface of the glass stack 11.

Here, the side surfaces of each glass piece 15 that constitute the principal surfaces (front and rear surfaces) of the glass stack 11 are cut surfaces that have been cut in a cutting step, which will be described later, and are not polished. Protrusions and depressions, which are marks that are formed during cutting, remain on the side surfaces of each glass piece 15. However, a side surface portion of each glass piece 15 in the glass stack 11 can be made transparent by the adhesive layer 12 coming into intimate contact with that side surface of the glass piece 15 and the cover plate 13. According to the present embodiment, polishing of one of the side surfaces of each glass piece 15 can be omitted.

Moreover, when the large number of glass pieces 15 are directly stacked one on top of another, minute gaps are formed between the glass pieces 15 that are adjacent to each other. Thus, in the glass stack 11, light that is obliquely incident from the side surfaces of the glass pieces 15 is totally reflected by principal surfaces (surfaces opposing each other in a thickness direction of the glass pieces) of the glass pieces 15 due to the difference between the refractive index of the glass pieces 15 and the refractive index of air in the minute gaps. That is to say, in the light control panel 10, light that is obliquely incident from the principal surface of the glass stack 11 is totally reflected by a principal surface of each glass piece 15 that functions as the strip-shaped reflective surface.

### 2. Optical Imaging Device and Aerial Image Forming System

As shown in FIG. 1, the optical imaging device 20 includes two light control panels 10. It should be noted that, hereinafter, in the description relating to the optical imaging device 20, in order to distinguish between the two light control panels 10, reference numerals in which “a” or “b” is added to the end of a number are used as the reference numerals denoting the light control panels 10 and constituent components thereof.

In the optical imaging device 20, glass stacks 11a and 11b are bonded to each other with an adhesive layer 16 (second adhesive layer) such that the strip-shaped reflective surfaces of the two light control panels 10a and 10b are substantially orthogonal to each other, and the glass stacks 11a and 11b face each other. In the light control panels 10a and 10b, the adhesive layer 16 is in intimate contact with one of the side surfaces of each of the glass pieces 15a and 15b of the glass stacks 11a and 11b. Thus, unpolished side surface portions can be made transparent. According to the present embodiment, polishing of the other side surface of each glass piece 15 can also be omitted. It should be noted that, in plan view, the angle that is formed by the strip-shaped reflective surfaces of the light control panel 10a with the strip-shaped reflective surfaces of the light control panel 10b can be 90°±2°, for example.

Next, an aerial image forming system 25 will be described. As shown in FIG. 2, the aerial image forming system 25 includes the optical imaging device 20 and a reproducing device 26 that is disposed behind the optical imaging device 20. The reproducing device 26 includes a display 27 that displays an image for an aerial image based on electronic data. The display 27 is capable of displaying still images or moving images. In FIG. 2, the display 27 is located below the optical imaging device 20 and faces the optical imaging device 20 side.

Light rays A and B from a point X of the display 27 are successively regularly reflected at points P of the strip-shaped reflective surfaces of the light control panel 10a and points Q of the strip-shaped reflective surfaces of the light control panel 10b. Then, the light rays A and B regularly reflected at the points Q converge at a point X′ above the optical imaging device 20. Moreover, light rays C and D from a point Y of the display 27 are successively regularly reflected at points R of the strip-shaped reflective surfaces of the light control panel 10a and points S of the strip-shaped reflective surfaces of the light control panel 10b. Then, the light rays C and D regularly reflected at the points S converge at a point Y′ above the optical imaging device 20. As a result, an image in the display 27 can be formed in free space in front of the optical imaging device 20, and an aerial image can thus be formed.

It should be noted that the “aerial image” can also be called a “floating image”. The aerial image forming system 25 can form a two-dimensional aerial image or can form a three-dimensional aerial image (stereoscopic image) in accordance with the image in the display 27. The aerial image forming system 25 can form an aerial touch screen, for example, as the two-dimensional aerial image or can form a character, for example, as the three-dimensional aerial image.

### 3. Method for Manufacturing Light Control Panel

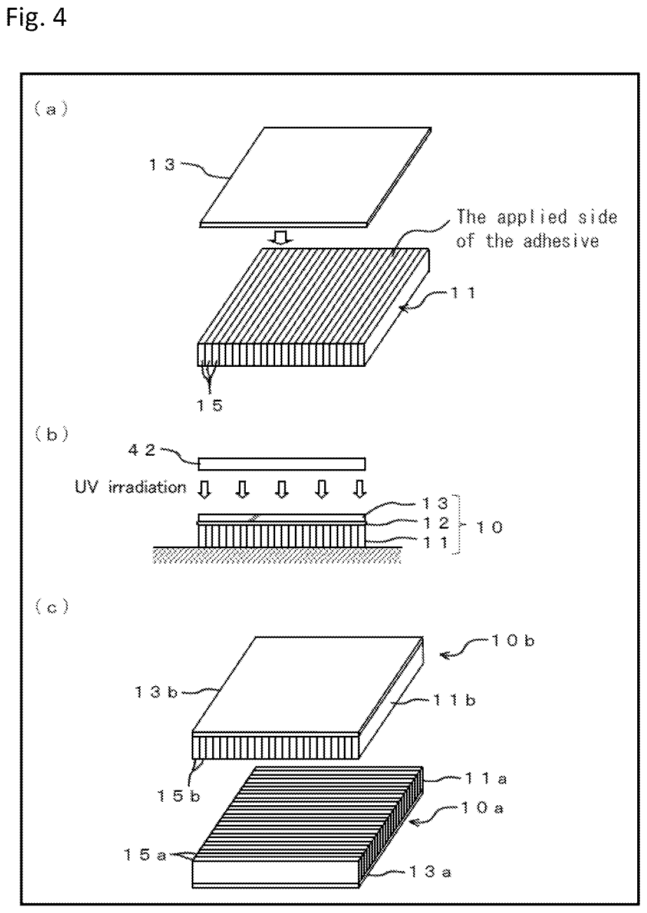

A method for manufacturing the light control panel 10 includes a cutting step, a washing step, a stacking step, and an integrating step. The method for manufacturing the light control panel 10 will now be described using FIGS. 3 and 4. It should be noted that, in FIG. 3, all of FIGS. 3(a) to 3(d) are perspective views. In FIG. 4, FIGS. 4(a) and 4(c) are perspective views, and FIG. 4(b) is a side view.

In the cutting step, first, as a material plate, a transparent glass sheet 30 (e.g., soda-lime glass substrate) having a rectangular flat plate-like shape is placed on a flat mount surface. A cutter 40 (e.g., laser cutter) is located above the transparent glass sheet 30. A cutter capable of fully cutting the transparent glass sheet 30 at a high speed (e.g., 1 m/second for a straight line portion) is used as the cutter 40. In the following description, as shown in FIG. 3(a), a direction that is parallel to one of the two pairs of opposite sides of the transparent glass sheet 30 is referred to as a “first direction”, and a direction that is parallel to the other of the two pairs of opposite sides is referred to as a “second direction”.

In the cutting step, in a state in which the transparent glass sheet 30 is fixed on the mount surface, as shown in FIG. 3(a), the transparent glass sheet 30 is cut from end to end with the cutter 40 while the cutter 40 is moved in the first direction. Subsequently, the position of the cutter 40 is shifted in the second direction for a predetermined set distance (distance corresponding to the width of the glass pieces 15), the transparent glass sheet 30 is cut from end to end in the first direction, and the position of the cutter 40 is shifted again in the second direction for the set distance. With respect to the cutter 40, “cutting in the first direction” and “shifting in the second direction” are repeated alternatingly. While moving back and force, the cutter 40 gradually moves in the second direction. Cutting of the transparent glass sheet 30 with the cutter 40 is performed with a predetermined pitch in the second direction. Consequently, as shown in FIG. 3(b), the transparent glass sheet 30 is divided into a plurality of glass pieces 15 having the same width. A plurality of transparent glass sheets 30 are used to manufacture a single light control panel 10.

It should be noted that after cutting in the first direction, the transparent glass sheet 30, instead of the cutter 40, may also be moved in the second direction (left direction in FIG. 3(a)) for the set distance. After this movement, cutting in the first direction is performed. Alternatively, a plurality of cutters 40 that are lined up with a constant pitch in the second direction may also be used. In this case, a plurality of portions can be cut at one time while the plurality of cutters 40 are moved together.

Subsequently, the washing step is performed in which glass powder that is generated by cutting is washed away. In the washing step, the surface of each glass piece 15 obtained in the cutting step is washed to remove the glass powder adhering to the glass piece 15. After washing, the glass pieces 15 are heat-dried.

Subsequently, the stacking step of producing a glass stack 11 by directly stacking a large number of elongated flat plate-shaped glass pieces 15 one on top of another is performed. In the stacking step, as shown in FIG. 3(c), the glass pieces 15 are placed upright such that the front and rear surfaces of the original transparent glass sheets 30 constitute stacked surfaces, and the side surfaces (cut surfaces) of each glass piece 15 constitute upper and lower surfaces. Then, the glass pieces 15 are stacked one on top of another with the ends of the glass pieces 15 in a longitudinal direction thereof being aligned, and thus, a rectangular flat plate-shaped glass stack 11 (see FIG. 3(d)) is produced. The last glass piece 15 is pressed toward the inside of the glass stack 11.

For example, a mold member 41 having at least two wall surfaces 41a and 41b that are orthogonal to each other can be used. In this case, the glass pieces 15 are moved one by one toward the wall surface 41a with end surfaces of the glass pieces 15 being in contact with the wall surface 41b, and in this manner, the glass pieces 15 are stacked one after another. The last glass piece 15 is pressed toward the wall surface 41a using a pressing jig.

Here, with regard to the method for placing the large number of glass pieces 15 upright, a temporary arrangement place with small ridges and troughs can be used. In this case, the large number of glass pieces 15 are placed on the temporary arrangement place in such a manner as to overlap each other, and the large number of glass pieces 15 in a slanting state are pushed in the lateral direction so as to become upright.

Alternatively, a robotic arm can be used. In this case, the robotic arm picks up a glass piece 15 on the mount surface by suction, then rotates the picked-up glass piece 15 by 90°, and places the glass piece 15 upright on a flat surface.

Subsequently, the integrating step of integrating the large number of glass pieces 15 of the glass stack 11 is performed. In the integrating step, first, a step of applying an ultraviolet-curable transparent adhesive (hereinafter referred to as a “UV adhesive”) to substantially the entire upper surface of the glass stack 11 that is placed on a flat surface is performed. Next, a step of stacking the cover plate 13 on the upper surface of the glass stack 11 in such a manner that the applied UV adhesive is sandwiched between the glass stack 11 and the transparent cover plate 13 is performed (see FIG. 4(a)). The cover plate 13 is stacked on the upper surface of the glass stack 11 so as to cover the entire upper surface, and is lightly pressed against the glass stack 11. It should be noted that the UV adhesive may be applied to a lower surface of the cover plate 13.

Then, a step of forming the adhesive layer 12 by curing the adhesive between the glass stack 11 and the cover plate 13 is performed. In this step, as shown in FIG. 4(b), ultraviolet rays are radiated from an irradiator 42 above the cover plate 13 toward the cover plate 13. The ultraviolet rays pass through the cover plate 13 and reach the UV adhesive. Thus, the UV adhesive is cured, and the adhesive layer 12 is formed. Each glass piece 15 is fixed to the cover plate 13, and the large number of glass pieces 15 are thus integrated. It should be noted that an adhesive (e.g., thermosetting adhesive) other than the UV adhesive may also be used to form the adhesive layer 12.

A light control panel 10 is completed through the above-described steps. It should be noted that in the manufacturing process for the light control panel 10, polishing of the side surfaces of the glass pieces 15 is not performed.

It should be noted that, depending on the flowability of the adhesive that is applied to the principal surface of the glass stack 11, the adhesive prior to being cured may flow into the minute gaps between the glass pieces 15 that are adjacent to each other. For this reason, an adhesive in a gel form or a highly viscous adhesive (adhesive composed of a resin with a high molecular weight) may be used so as not to allow the adhesive to flow into the minute gaps. If the adhesive can be prevented from flowing into the minute gaps, in the glass stack 11, the entire surfaces of the glass pieces 15 that are adjacent to each other directly face each other. However, even if the adhesive enters between adjacent glass pieces 15 on the adhesive layer 12 side of the glass stack 11 with respect to the thickness direction, the light control panel 10 functions properly as long as a certain width of the strip-shaped reflective surfaces is secured. In this case, it is desirable that the entry of the adhesive stops midway on the adhesive layer 12 side so that minute gaps are formed in a range that is half or more of the thickness of the glass stack 11, for example.

Next, a method for manufacturing the optical imaging device 20 will be described. This manufacturing method includes a bonding step of bonding the two light control panels 10a and 10b to each other.

In the bonding step, as shown in FIG. 4(c), the glass stack 11 sides of the two light control panels 10a and 10b are opposed to each other such that the longitudinal directions of the glass pieces 15a and 15b of the respective light control panels 10a and 10b are substantially orthogonal to each other. In this state, or immediately before this state is established, a transparent adhesive is applied to substantially the entire principal surface of the glass stack 11a/11b of at least one of the light control panels 10a and 10b. Then, from this state, the two light control panels 10a and 10b are stacked one on top of the other without changing the orientation of the light control panels 10a and 10b. The adhesive layer 16 is formed as a result of the adhesive curing, and the two light control panels 10 are bonded to each other. Thus, the optical imaging device 20 shown in FIG. 1 is completed. It should be noted that illustration of the adhesive layers 12a and 12b is omitted from FIG. 4(c).

### 4. Effects and the Like of Embodiment

According to the present embodiment, unlike the conventional method, a large number of glass pieces 15 are directly stacked one on top of another in the stacking step. No adhesive is provided between adjacent glass pieces 15 in the stacking step. Instead, the large number of glass pieces 15 are integrated by the adhesive layer 12 and the cover plate 13 that are successively stacked on a principal surface of the glass stack 11. Accordingly, although an adhesive is used on the principal surface of the glass stack 11, an adhesive in gaps between adjacent glass pieces 15, where a large amount of adhesive has conventionally been used, can be reduced, so that the manufacturing cost of the light control panel 10 can be reduced.

Moreover, according to the present embodiment, a transparent glass piece without a metal reflective film (mirror) on either side is used as each glass piece 15. Therefore, a large number of metal reflective layers (mirror sheets or vapor-deposited metal films), which have conventionally been used, are not used, so that the manufacturing cost of the light control panel 10 can be reduced even more.

Moreover, according to the present embodiment, unlike the conventional method, a block from which a plurality of light control panels are cut out is not produced, but instead, a glass stack 11 used for a single light control panel 10 is produced from a large number of glass pieces 15. Compared with the block, the glass stack 11 is lightweight. Therefore, although it has conventionally been difficult to increase the size of a light control panel under constraints of the weight of the block, the constraints of the weight are alleviated according to the present invention, so that the size of the light control panel 10 can be increased.

Moreover, according to the present embodiment, polishing of the side surfaces of each glass piece 15 can be omitted as described above, so that the manufacturing cost of the light control panel 10 can be reduced even more.

### 5. Modifications

According to the foregoing embodiment, the optical imaging device 20 has a rectangular shape in plan view. However, the optical imaging device 20 may have a trapezoidal shape as is the case with an optical imaging device disclosed in WO 2013/145983 or may have other polygonal shapes.

Moreover, according to the foregoing embodiment, a transparent glass piece with no metal reflective film on either side is used as each glass piece 15. However, a glass piece having a metal reflective film on one side may also be used. In this case, prior to the cutting step, a metal reflective film is formed on one side of the transparent glass sheet 30 through vapor deposition of metal or the like, and in the cutting step, the transparent glass sheet 30 on which the metal reflective film is formed is divided into a plurality of glass pieces 15. Then, in the stacking step, a large number of glass pieces 15 are directly stacked one on top of another such that the metal reflective films thereon face the same side. It should be noted that glass pieces 15 each with metal reflective films on both sides may also be used.

Moreover, according to the foregoing embodiment, polishing of the side surfaces of each glass piece 15 is not performed. However, polishing of the side surfaces on the long sides of each glass piece 15 may be performed. In this case, a configuration may also be adopted in which the adhesive layer 12 and the cover plate 13 are not provided, and the large number of glass pieces 15 are integrated using a different means. For example, a fixation portion that integrates the large number of glass pieces 15a of the light control panel 10a may be constituted by the light control panel 10b, to which the light control panel 10a is joined, and the adhesive layer 16. Moreover, the large number of glass pieces 15 may be integrated by bonding a plate to a side surface in which the large number of glass pieces 15 are lined up, of the side surfaces of the glass stack 11 with an adhesive.

Moreover, in the foregoing embodiment, the strip-shaped reflective surfaces may be inclined relative to a plane that is parallel to the thickness direction of the light control panel 10 as in the case of an optical imaging device disclosed in WO 2014/024677. In this case, glass pieces 15 having a parallelogrammic shape when viewed in cross section are stacked one on top of another.

Moreover, in the foregoing embodiment, each light control panel 10 may include a plurality of glass stacks 11 that are stacked one on top of another as in the case of an optical imaging device disclosed in Japanese Patent No. 5646110. The positions of the strip-shaped reflective surfaces of the plurality of glass stacks 11 are shifted against each other in the direction in which the glass pieces 15 are lined up.

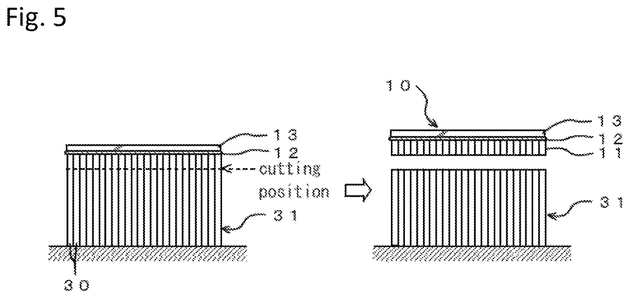

Moreover, according to the foregoing embodiment, the stacking step is performed after the cutting step. However, the cutting step may also be performed after the stacking step. Specifically, in a method for manufacturing the light control panel 10 according to a modification, a rectangular parallelepiped-shaped stack 31 (see FIG. 5) in which a large number of transparent glass sheets 30 are directly stacked one on top of another is produced by performing a stacking step. Next, an adhesively bonding step is performed in which an adhesive is applied to a principal surface of the stack 31, the cover plate 13 is then placed thereon, the adhesive layer 12 is formed by curing the adhesive, and thus, side surfaces of the large number of transparent glass sheets 30 are adhesively bonded to the cover plate 30. Next, a cutting step is performed in a state in which the large number of transparent glass sheets 30 are bound together. In the cutting step, the large number of transparent glass sheets 30 are cut in the stacking direction at a cutting position shown in FIG. 5. Thus, a light control panel 10 is produced. Furthermore, with respect to the remaining stack 31, the adhesively bonding step and the cutting step are performed alternatingly, and thus, a plurality of light control panels 10 are produced. It should be noted that the adhesively bonding step may also be performed after the cutting step. The light control panel according to the present invention includes the light control panels 10 that are manufactured by using the manufacturing method described in this paragraph.

### INDUSTRIAL APPLICABILITY

The present invention is applicable to a method for manufacturing a light control panel for use in an optical imaging device that forms an image in the air, and the like.

### LIST OF REFERENCE NUMERALS

10 Light control panel
11 Glass stack
12 Adhesive layer
13 Cover plate
15 Glass piece
20 Optical imaging device
25 Aerial image forming system
30 Transparent glass sheet
40 Cutter

1. A method for manufacturing a light control panel in which a large number of strip-shaped reflective surfaces are formed with a constant pitch in a direction that is perpendicular to a thickness direction of the light control panel, the method comprising:
a stacking step of directly stacking a large number of elongated flat plate-shaped glass pieces one on top of another without interposing an adhesive between the glass pieces, thereby producing a glass stack, which has a flat plate-like shape and in which the large number of glass pieces are lined up in a direction that is perpendicular to a thickness direction of the glass stack; and
an integrating step of integrating the large number of glass pieces of the glass stack,
wherein pieces of transparent glass with no reflective films for forming the strip-shaped reflective surfaces being stacked thereon are used as the glass pieces.

2. The method for manufacturing a light control panel according to claim 1,
wherein the integrating step includes:
a step of applying a transparent adhesive to at least one of one side of the glass stack and one side of a transparent cover plate;
a step of stacking the cover plate on one side of the glass stack such that the adhesive is sandwiched between the glass stack and the cover plate; and
a step of forming an adhesive layer by curing the adhesive between the glass stack and the cover plate.

3. The method for manufacturing a light control panel according to claim 2, the method further comprising:
a cutting step of cutting a transparent glass sheet, thereby dividing the transparent glass sheet into a plurality of glass pieces for use in the stacking step,
wherein polishing of side surfaces on the long sides of each glass piece is not performed.

4. A light control panel in which a large number of strip-shaped reflective surfaces are formed with a constant pitch in a direction that is perpendicular to a thickness direction of the light control panel, the light control panel comprising:
a glass stack that has a flat plate-like shape and that is constituted by a large number of elongated flat plate-shaped glass pieces that are directly stacked one on top of another in a direction that is perpendicular to a thickness direction of the glass stack: and
a fixation portion that integrates the large number of glass pieces of the glass stack,
wherein, in each of the glass pieces, one of the principal surfaces of the glass piece that oppose each other in a thickness direction of the glass piece functions as the strip-shaped reflective surface,
pieces of transparent glass with no reflective films for forming the strip-shaped reflective surfaces being stacked thereon are used as the glass pieces, and
in the glass stack, the principal surfaces of the glass pieces function as the strip-shaped reflective surfaces due to a difference between a refractive index of air in minute gaps between the glass pieces that are adjacent to each other and a refractive index of the glass pieces.

5. The light control panel according to claim 4,
wherein the fixation portion has:
an adhesive layer that is in contact with one side of the glass stack and that is composed of a cured transparent adhesive; and
a transparent cover plate that is adhesively bonded to a side of the adhesive layer, the side being opposite to the glass stack, in such a manner as to cover the one side of the glass stack.

6. The light control panel according to claim 5,
wherein protrusions and depressions remain on side surfaces of each glass piece of the glass stack as marks that are formed during cutting.

7. An optical imaging device comprising:
two of said light control panels according to claim 4,
wherein the two light control panels are bonded to each other via a second adhesive layer such that their strip-shaped reflective surfaces are substantially orthogonal to each other, and the glass stacks of the light control panels face each other.

8. An aerial image forming system comprising:
the optical imaging device according to claim 7; and
a reproducing device that is disposed behind the optical imaging device and that displays an image in a display based on electronic data,
wherein an aerial image is formed by forming the image in the display in free space in front of the optical imaging device.

9. An optical imaging device comprising:
two of said light control panels according to claim 5,
wherein the two light control panels are bonded to each other via a second adhesive layer such that their strip-shaped reflective surfaces are substantially orthogonal to each other, and the glass stacks of the light control panels face each other.

10. An aerial image forming system comprising:
the optical imaging device according to claim 9; and
a reproducing device that is disposed behind the optical imaging device and that displays an image in a display based on electronic data,
wherein an aerial image is formed by forming the image in the display in free space in front of the optical imaging device.

11. An optical imaging device comprising:
two of said light control panels according to claim 6,
wherein the two light control panels are bonded to each other via a second adhesive layer such that their strip-shaped reflective surfaces are substantially orthogonal to each other. and the glass stacks of the light control panels face each other.

12. An aerial image forming system comprising:
the optical imaging device according to claim 11; and
a reproducing device that is disposed behind the optical imaging device and that displays an image in a display based on electronic data,
wherein an aerial image is formed by forming the image in the display in free space in front of the optical imaging device.
